(19) United States
(12) Patent Application Publication
(10) Pub. No.: US 2024/0409236 A1
(43) Pub. Date: Dec. 12, 2024

(54) DRONE PROTECTION SYSTEM

(71) Applicant: Nippon Telegraph and Telephone Corporation, Tokyo (JP)

(72) Inventors: Naruto ARAI, Musashino-shi, Tokyo (JP); Toshihisa MASUDA, Musashino-shi, Tokyo (JP); Masato MARUYAMA, Musashino-shi, Tokyo (JP); Jun KATO, Musashino-shi, Tokyo (JP)

(21) Appl. No.: 18/695,427

(22) PCT Filed: Oct. 11, 2021
(86) PCT No.: PCT/JP2021/037542

§ 371 Date: Mar. 26, 2024

(51) Int. Cl. B64D 45/02; B64C 39/02

(52) U.S. Cl. CPC B64D 45/02; B64C 39/024

(57) ABSTRACT

A drone protection system that protects a drone from lightning strikes includes a Faraday cage enclosing the drone; and a wire capable of moving along the Faraday cage while maintaining connection with the Faraday cage with an end portion (connection unit) connecting to the Faraday cage.

### TECHNICAL FIELD

The present invention relates to a drone protection system.

### BACKGROUND ART

Drone protection against lightning strikes is widely known. For example, a Faraday cage is attached to a drone to enclose the drone and grounded to the ground with a wire, thereby preventing the drone from falling due to lightning strike (see Non Patent Literature 1).

### CITATION LIST

### Non Patent Literature

Non Patent Literature 1: Masuda and three others, “Doron no tairaisei koujyou ni kansuru kisoteki kentou (in Japanese) (Fundamental Study on Improving Lightning Resistance of Drones)”, 2021 IEICE Society Conference, Sep. 14 to 17, 2021, online, Proceedings of Correspondence Lecture 1, B-4-6, p.179

### SUMMARY OF INVENTION

### Technical Problem

However, since the connection between the Faraday cage and the wire is fixed at a single contact, a movable range of the drone is restricted. In a case where a plurality of drones (a plurality of Faraday cages) are connected by a wire, the movable range of the drone is also restricted for the same reason.

In a case where the wire is tensioned, the Faraday cage is inclined by the tension of the wire, and the drone is also inclined, whereby it is difficult to horizontally stabilize the drone body.

The present invention has been made to address the problems above, and an object of the present invention is to provide a technology capable of horizontally holding a drone and expanding a movable range of the drone.

### Solution to Problem

A drone protection system according to one aspect of the present invention is a drone protection system that protects a drone from lightning strike, which includes a Faraday cage enclosing the drone; and a wire capable of moving along the Faraday cage while maintaining connection with the Faraday cage with an end portion connecting to the Faraday cage.

### Advantageous Effects of Invention

According to the present invention, it is possible to provide a technology capable of horizontally holding a drone and expanding a movable range of the drone.

### BRIEF DESCRIPTION OF DRAWINGS

FIG. 1 is a diagram illustrating a structure example of a Faraday cage including a drone.

FIG. 2 illustrates a structure example of a wire.

FIG. 3 is a diagram illustrating a connection state between the Faraday cage and the wire.

FIG. 4 is a diagram illustrating a use example of the drone protection system.

FIG. 5 is a diagram illustrating a use example of the drone protection system.

FIG. 6 is a diagram illustrating a use example of the drone protection system.

### DESCRIPTION OF EMBODIMENTS

The following is a description of embodiments of the present invention, with reference to the drawings. In the drawings, the same parts are denoted by the same reference signs, and the description thereof is omitted.

### Summary of Invention

The present invention solves the problems above by designing a shape of a Faraday cage attached to a drone and also a shape of an end portion (a portion connected to the Faraday cage) of a wire connecting drones or connecting a drone and an object other than a drone (for example, the ground or a grounded electrode connected to the ground).

In particular, the present invention allows the end portion of the wire to move along the Faraday cage while maintaining connection with the Faraday cage. For example, a rail-shaped groove is provided on an outer surface of the Faraday cage, and the end portion of the wire is shaped to be fitted into the groove.

### Configuration of Drone Protection System

The drone protection system according to the present embodiment is a drone protection system that protects a drone from lightning strike. The drone protection system includes a Faraday cage and a wire.

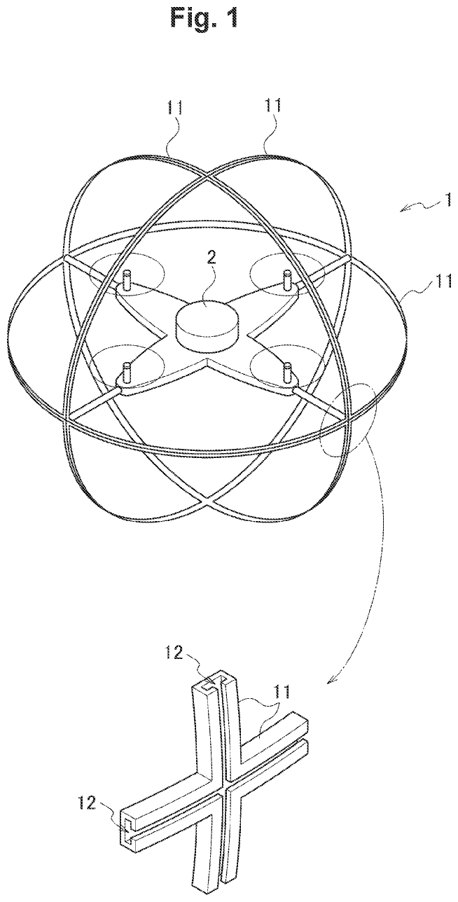

FIG. 1 is a diagram illustrating a structure example of a Faraday cage 1. As illustrated in FIG. 1, the Faraday cage 1 is a conductor made of a conductive material such as aluminum or copper, inside of which a drone 2 is attached and which encloses the entire drone 2.

The Faraday cage 1 according to the present embodiment has a structure in which three linear conductors 11 having the same diameter and a ring shape are assembled in a lattice, and the overall shape is a sphere. A rail-shaped groove 12 having an inverted T-shaped cross-section is provided on an outer surface of each linear conductor 11.

The groove 12 may be made by directly forming the groove on the outer surface of the linear conductor 11 as illustrated on the lower side of FIG. 1, or alternatively, by adding a structure of a conductive material including the groove to the outer surface of the linear conductor 11.

FIG. 1 illustrates a case where three ring-shaped linear conductors 11 having the same diameter are used in terms of structural visibility of the Faraday cage 1. However, a plurality of linear conductors having gradually smaller diameters may be further assembled to increase the density of the linear conductors. The entire Faraday cage 1 may into a cube shape by assembling rectangular linear conductors in a lattice. That is, the present invention is applicable to any existing or future developed Faraday cage.

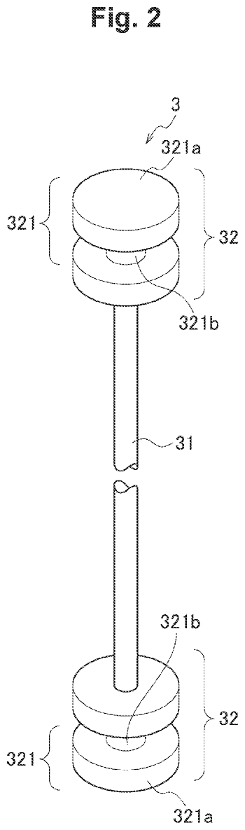

FIG. 2 illustrates a structure example of the wire 3. The wire 3 according to the present embodiment includes one wire unit 31 and two connection portions 32 (end portions) for connecting the wire unit 31 to the Faraday cage 1.

The wire unit 31 is a linear conductor made of a conductive material such as aluminum or copper.

The two connection portions 32 are provided at two end portions (both end portions of the linear conductor) of the wire unit 31, and have a structure capable of moving along the Faraday cage 1 while maintaining connection with the Faraday cage 1. In particular, the connection portion 32 has a shape that fits into the inverted T-shaped groove 12 provided on the Faraday cage 1. For example, the connection portion 32 has an H-shaped cross-section as illustrated in FIG. 2 or a T-shaped cross-section (not illustrated).

In other words, the connection portion 32 includes a T-shaped protrusion 321 that fits into the groove 12 of the Faraday cage 1. The thickest portion 321a of the protrusion 321 is thicker than the thinnest portion of the inverted T-shaped groove 12 (the “I” portion of the “T”) and thinner than the thickest portion of the inverted T-shaped groove 12 (the “-” portion of the “T”). The thinnest portion 321b of the protrusion 321 is thinner than the thinnest portion of the inverted T-shaped groove 12.

The connection portion 32 may be made of a conductive material such as aluminum or copper, or may be made of an insulator such as plastic. The connection portion 32 may be made of an insulator because lightning generally has a high voltage, and even if the connection portion is made of a short insulator, a current passes through the connection portion.

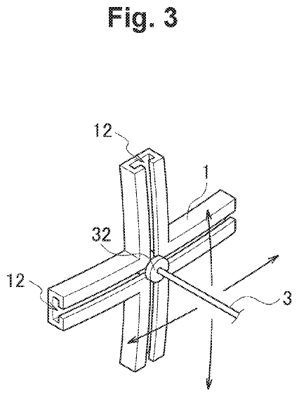

FIG. 3 is a diagram illustrating an example of connection between the Faraday cage 1 and the wire 3. The connection portion 32 of the wire 3 is fitted into the inverted T-shaped groove 12 provided on the outer side of the Faraday cage 1. The connection portion 32 of the wire 3 is capable of moving along the groove 12 of the Faraday cage 1. Therefore, when the drone 2 moves, the connection (connection position) between the Faraday cage 1 and the wire 3 moves in conjunction with the movement.

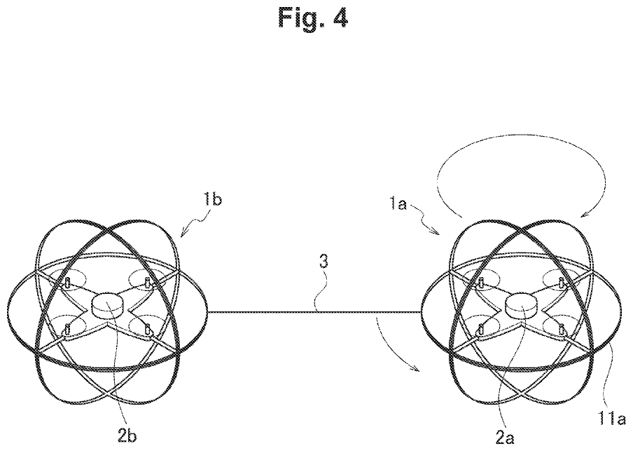

For example, as illustrated in FIG. 4, in a case where two Faraday cages 1a and 1b related to two drones 2a and 2b are connected by one wire 3, when one drone 2a rotates to the right, the wire 3 slides along a groove of a horizontal linear conductor 11a of the Faraday cage 1a.

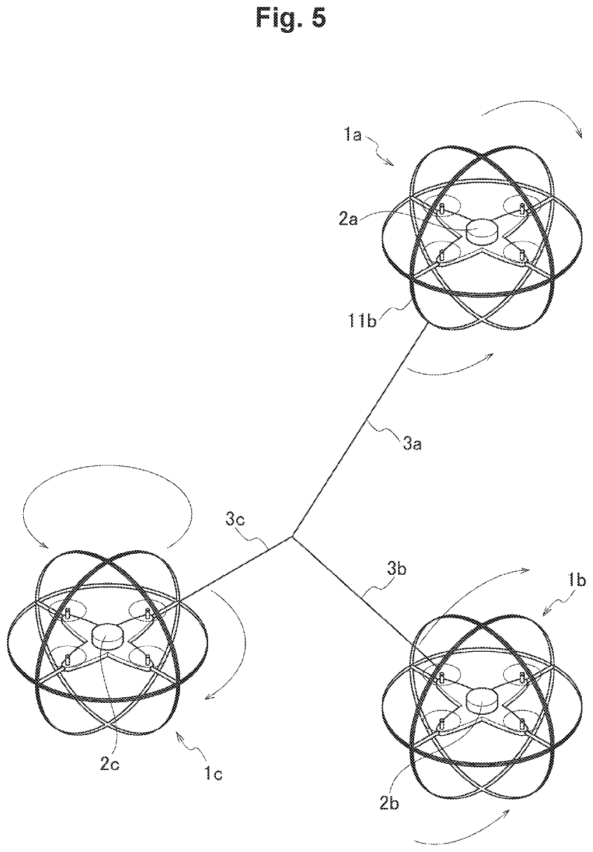

For example, as illustrated in FIG. 5, in a case where three Faraday cages 1a, 1b and 1c related to three drones 2a, 2b and 2c are connected by three wires 3a, 3b and 3c, when one drone 2a rotates upward, the wire 3a slides along a groove of a vertical linear conductor 11b of the Faraday cage 1a.

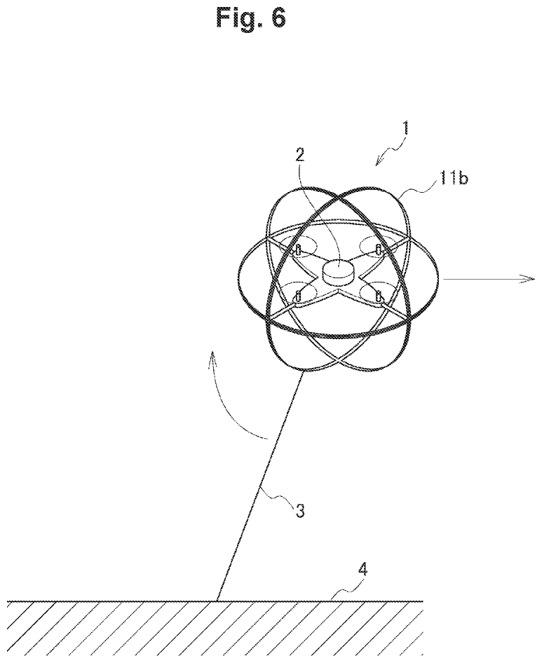

For example, as illustrated in FIG. 6, in a case where the Faraday cages 1 of the drone 2 is grounded to the ground 4 via the wire 3, when the drone 2 moves forward, the wire 3 slides along a groove of a vertical linear conductor 11b of the Faraday cage 1.

### Effects of Present Embodiment

According to the present embodiment, the wire 3 can move on the Faraday cage 1 while maintaining connection between the end portion of the wire 3 and the Faraday cage 1, that is, the rail-shaped groove 12 is provided on the outer side of the Faraday cage 1 for protecting a drone 2 from lightning strike, and the wire 3 connecting the drones 2 or connecting the drone 2 and an object other than the drone (e.g. ground 4) has the connection portion 32 with the protrusion fitting into the groove 12, and thereby the connection (connection position) between the Faraday cage 1 and the wire 3 moves in response to movement of the drone 2. Therefore, the drone body can be easily held in the horizontal direction even in a case where the wire 3 is tensioned and the drone 2 is less likely to fall. Additionally, the movable range of the drone 2 can be expanded for the same reason.

### REFERENCE SIGNS LIST

1 Faraday cage
11 Linear conductor
12 Groove
2 Drone
3 Wire
31 Wire unit
32 Connection unit
321 Protrusion
4 Ground

1. A drone protection system that protects a drone from lightning strike, the drone protection system comprising:
a Faraday cage enclosing the drone; and
a wire capable of moving along the Faraday cage while maintaining connection with the Faraday cage with an end portion connecting to the Faraday cage.

2. The drone protection system according to claim 1, wherein the Faraday cage
is a linear conductor having a groove on an outer side, and
the end portion has a shape that fits into the groove.

3. The drone protection system according to claim 2, wherein the groove has an inverted T-shaped cross-section.
